(19) United States
(12) Patent Application Publication
(10) Pub. No.: US 2011/0278011 A1
(43) Pub. Date: Nov. 17, 2011

(54) MATERIALS AND METHODS FOR TEMPORARILY OBSTRUCTING PORTIONS OF DRILLED WELLS

(75) Inventors: Victor A. Crainich, JR., Dayton, OH (US); Sidney D. Osborn, Dayton, OH (US)

(73) Assignee: CHEMICAL DELIVERY SYSTEMS, INC., Kettering, OH (US)

(21) Appl. No.: 13/107,871

(22) Filed: May 13, 2011

Related U.S. Application Data
(60) Provisional application No. 61/334,677, filed on May 14, 2010.

(51) Int. Cl. E21B 43/00; C08G 64/00; C09K 8/50

(52) U.S. Cl. 166/310; 507/219; 507/212; 507/230; 528/370

(57) ABSTRACT

In various embodiments, provided are materials and methods for controlling the flow of water, steam, drilling fluid, hydraulic stimulation fluid, hydrocarbon (oil or gas), or combinations thereof, in drilled wells (such as enhanced geothermal system wells, oil wells, or natural gas wells) by at least partially and temporarily obstructing one or more of a geologic fracture, perforation, or wellbore in a reversible manner.

### CROSS REFERENCE TO RELATED APPLICATIONS

This application claims priority to and any other benefit of U.S. provisional application No. 61/334,677, filed May 14, 2010, the entirety of which is incorporated by reference herein.

### FIELD

This application relates to materials and methods for controlling flow in drilled wells by at least partially obstructing one or more of a geologic fracture, perforation, or wellbore in a reversible manner.

### BACKGROUND

Geothermal energy resources are traditionally accessed by drilling wells in a process similar to drilling for oil or gas. Such wells are relatively shallow (typically less than 5 km) and are drilled to access fluids (water or steam) derived from surface waters that have percolated into the earth along permeable pathways such as pores, fractures, joints, faults, and other openings. The presence of available fluids decreases as depth increases. Additionally, because pathways tend to compress from the weight of the earth above, permeability (and the ability of fluids to flow through rock) decreases as depth increases. Heat, fluids, and permeable rock that coincide at shallow depths result in natural geothermal reservoirs that can be harnessed for energy production, provided that such reservoirs also have sufficient fluid pressures. However, the coincidence of such factors is not commonplace, thereby limiting the number of traditional geothermal energy conversion facilities that can be built. Nevertheless, there are prodigious amounts of heat located everywhere beneath the earth's surface that could be harnessed for production of energy if reliable alternatives to traditional geothermal methods and technologies can be developed.

Enhanced Geothermal Systems (EGS) are alternative energy generation systems, wherein wells are drilled into hot rock lacking the requisite coincidence of permeability and fluids. Typically, the rock formations that are most suitable for EGS operation are deep and highly fractured. Because permeability is low at the depths typically associated with EGS, existing fractures in the impermeable rock matrix are hydraulically enhanced, or new fractures are created. Such engineering techniques create permeability pathways that propagate to each other, are parallel to each other, or combinations thereof. Engineering of the rock matrix continues until it becomes suitable for use as a reservoir for extracting thermal energy by the circulation of water between injection and production wells. In an EGS system, water is injected into the engineered reservoir, maintained at suitable pressures to create circulation (but at pressures below the tensile strength of the rock), flows along the engineered permeable pathways while absorbing thermal energy from hot rock, and exits the reservoir through production wells. At the surface, the hot water/steam passes through a power plant where electricity is generated from thermal energy, and the water/steam condensate is then returned to the reservoir through injection wells to complete the circulation loop.

EGS is a new green technology, and in order for it to develop and expand into a competitive energy resource, significant advances in reservoir creation, well field development and operation, and power conversion are needed. Some of the advances needed are new materials and methods capable of functioning in unique EGS environments (deep well depths, high temperature, high pressure, hard crystalline rock, reactive fluids, and other such conditions). Because the costs required to drill wells increases non-linearly as well depth increases, drilling can represent up to 50% of the overall costs to produce electrical energy from EGS. Thus, there is also a need for technologies that could be utilized to reduce drilling and other operational costs.

While EGS environments are unique, the need to reduce drilling and other operational costs is not limited to EGS. There is also need to reduce such costs for oil wells, natural gas wells, and other drilled wells. In particular, because hydrocarbons (oil and natural gas) remain viable energy resources, there is a particular need for materials and methods that can be used in their efficient exploration and production. Hydrocarbon technologies are capable of use in wells as deep as about 5 km, but are typically used in shallower wells. In some cases, such basic technology can be exploited for EGS applications but typically have to be modified for EGS use. For example, EGS wells have diameters that are generally larger than those of hydrocarbon wells, which creates issues relating to borehole stability. Also, EGS wells are typically drilled into rock that is harder than that encountered for hydrocarbon purposes, which creates issues with equipment reliability. Additionally, EGS exploration, drilling, and operation require a greater knowledge about fracture and fault systems with respect to their role as potential water/steam conduits, as well as rock porosity and stress field at great depths. Thus, in order to overcome these differences, adaptation of some known technologies is required for EGS.

Although some hydrocarbon technologies can be modified for EGS applications, other technologies are unsuitable for use in EGS. Importantly, because EGS depends upon high temperatures, materials suitable for use in hydrocarbon wells are largely unsuitable for EGS applications. EGS wells frequently operate at temperatures greater than 150° C., which is beyond the threshold of current hydrocarbon technologies. Moreover, some of the materials and methods useful at high temperatures in natural geothermal systems are not suitable for use in EGS wells. Thus, EGS requires new materials and methods for treating a wellbore and formation penetrated by a wellbore, wherein said materials and methods are reliably functional under the unique EGS conditions. Also, because the main advantage of EGS is that it can be located outside of traditional geothermal fields where high temperature gradients exist at relatively shallow depths, there is a need for materials and methods that are functional and controllable at well depths greater than 5 km. Temperatures, pressures, and other conditions at such depths are largely unknown and are beyond the capabilities (and control) of hydrocarbon and traditional geothermal technologies. Thus, EGS requires reliable equipment, materials, and methods that can, among other requirements, function at high depths (for example, up to 8 km) and at high temperatures (for example, above 150° C.).

In light of the above, the present application provides materials and methods suitable for use in drilled wells, including but not limited to, EGS wells.

### SUMMARY

In various embodiments, provided are materials and methods for controlling flow in drilled wells (including, but not limited to, enhanced geothermal system wells, oil wells, and natural gas wells) by at least partially obstructing one or more of a geologic fracture, perforation, or wellbore in a reversible manner. In some embodiments, the provided materials and methods may be used to control the flow of water, steam, drilling fluid, hydraulic stimulation fluid, hydrocarbon (oil or gas), or combinations thereof in drilled wells.

In some of the various embodiments, the present application provides compositions for use in reversibly controlling flow in a drilled well. In some embodiments, the provided compositions comprise a thermoplastic material adapted to (i) when in solid phase, at least partially obstruct flow in one or more of a geologic fracture, a perforation, or a wellbore; (ii) undergo at least a partial phase transition between solid phase and fluid phase at a first pre-determined geostatic temperature; and (iii) not obstruct flow in or to the one or more geologic fracture, perforation, or wellbore at or above the first pre-determined geostatic temperature. The thermoplastic material of the provided compositions may comprise one or more suitable elastomers, polymers, and copolymers. In addition to thermoplastic material, the provided compositions may, in some embodiments, further comprise one or more binders that aid in the formation of at least a partial plug in the one or more geologic fracture, perforation, or wellbore.

The present application also provides, in some of the various embodiments, methods of treating a drilled well to reversibly control flow in or to one or more of a geologic fracture, a perforation, or wellbore. In some embodiments, the provided methods comprise (i) preparing a pumpable mixture by mixing with water a composition comprising a thermoplastic material adapted to (a) when in solid phase, at least partially obstruct flow in or to the one or more geologic fracture, perforation, or wellbore; (b) undergo at least a partial phase transition between solid and fluid phases at a first pre-determined geostatic temperature; and (c) not obstruct flow in or to the one or more geologic fracture, perforation, or wellbore at or above the first pre-determined geostatic temperature; (ii) injecting the pumpable mixture into one or more target zones of a drilled well selected from an enhanced geothermal system well, an oil well, and a natural gas well; (iii) causing the pumpable mixture to aggregate in the one or more of a geologic fracture, perforation, or wellbore of the one or more target zones; (iv) decreasing flow in or to the one or more geologic fracture, perforation, or wellbore by allowing the aggregated pumpable mixture to form at least a partial plug; and (v) increasing flow in or to the one or more geologic fracture, perforation, or wellbore by allowing temperature of the one or more target zones and at least partial plug therein to increase to at least the first pre-determined geostatic temperature; wherein at or above the first pre-determined geostatic temperature, the at least partial plug at least partially destructs.

### DESCRIPTION OF EMBODIMENTS

Specific embodiments of the present application will now be described. The invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this application belongs. The terminology used in the present application is for describing particular embodiments only and is not intended to be limiting of the invention. As used in the specification and appended claims, the singular forms “a,” “an,” and “the” are intended to include the plural forms as well, unless the context clearly indicates otherwise.

Unless otherwise specifically described, the terms “particle” and “particulate” are used in the specification and appended claims to mean a physical unit of a described material having any shape, whether spherical, non-spherical, symmetrical, non-symmetrical, or amorphous. Examples of particles include, but are not limited to, fibers, platelets, shavings, flakes, granules, ribbons, rods, strips, strands, spheroids, toroids, pellets, tablets, and crystals.

“Particle size,” as used in the specification and appended claims, may be determined by any standard method known to one of skill in the art. For example, particle size may be determined by reference to the smallest standard mesh or sieve through which the particles will not pass. Thus, a particle able to pass through a Tyler Mesh Size of 48 but not Tyler Mesh Size 60 would have a particle size of between 250 μm and 297p.m. For avoidance of doubt, non-limiting examples of standard mesh or sieve sizes are listed in Table I. Another non-limiting method of determining particle size includes use of a laser diffraction analyzer, such as a Microtrac® 100 particle size analyzer.

TABLE I

| | | Standard |
|---|---|---|
| US Sieve Size | Tyler Mesh Size | Opening (mm) |
| 6 | 6 | 3.36 |
| 7 | 7 | 2.83 |
| 8 | 8 | 2.38 |
| 10 | 9 | 2.00 |
| 12 | 10 | 1.68 |
| 14 | 12 | 1.41 |
| 16 | 14 | 1.19 |
| 18 | 16 | 1.00 |
| 20 | 20 | 0.841 |
| 25 | 24 | 0.707 |
| 30 | 28 | 0.595 |
| 35 | 32 | 0.500 |
| 40 | 35 | 0.420 |
| 45 | 42 | 0.354 |
| 50 | 48 | 0.297 |
| 60 | 60 | 0.250 |
| 70 | 65 | 0.210 |
| 80 | 80 | 0.177 |
| 100 | 100 | 0.149 |
| 120 | 115 | 0.125 |
| 140 | 150 | 0.105 |
| 170 | 170 | 0.088 |
| 200 | 200 | 0.074 |
| 230 | 250 | 0.063 |
| 270 | 270 | 0.053 |
| 325 | 325 | 0.044 |
| 400 | 400 | 0.037 |

As used in the specification and appended claims, the term “phase transition” is intended to mean a change from one physical state to another (for example, solid to liquid or liquid to solid) without a change in chemical composition. Thus, a phase transition is not a change in a material resulting from hydrolytic degradation, enzymatic degradation, or biological degradation.

“Geostatic temperature,” as used in the specification and appended claims, is intended to refer to the mean temperature exerted by subsurface rock, sediment, fluids, or combinations thereof on a defined section of a drilled well.

As used in the specification and appended claims, the term “obstruct” is intended to mean to block, close, or otherwise plug such that flow of water, steam, drilling fluid, hydraulic stimulation fluid, oil, gas, or other flowable material is restricted from passage, action, or operation. “Partially obstruct” means to partially block, close, or plug such that flow of water, steam, drilling fluid, hydraulic stimulation fluid, oil, gas, or other material is reduced (as compared to unobstructed flow) but not restricted from passage, action, or operation. Accordingly, “at least partially obstruct” means to obstruct, to partially obstruct, or both.

Unless otherwise indicated, all numbers expressing quantities of ingredients, properties such as molecular weight, reaction conditions, and so forth as used in the specification and claims are to be understood as being modified in all instances by the term “about,” which is intended to mean up to ±10% of an indicated value. Additionally, the disclosure of any ranges in the specification and claims are to be understood as including the range itself and also anything subsumed therein, as well as endpoints. Unless otherwise indicated, the numerical properties set forth in the specification and claims are approximations that may vary depending on the desired properties sought to be obtained in the described embodiments. Notwithstanding that numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### I. Materials

In various embodiments, the present application provides materials adapted to be useful in controlling flow in drilled wells (such as oil, natural gas, and EGS wells) by at least partially obstructing one or more of a geologic fracture, perforation, or wellbore in a reversible manner. As one illustrative example, the provided materials are believed to be suitable for temporarily obstructing fractures encountered in the drilling and formation of a well such that the flow of drilling fluid in or to said fractures is controlled.

In various embodiments, it is contemplated that the provided materials for reversibly controlling flow in one or more of a geologic fracture, perforation, or wellbore may be used to control the flow of water, drilling fluid, hydraulic stimulation fluid, hydrocarbon (oil or gas), or combinations thereof in wells such as EGS, oil, or natural gas wells.

In some of the various embodiments, provided are compositions comprising a thermoplastic material adapted to (i) at least partially obstruct flow in or to one or more of a geologic fracture, a perforation, or a wellbore when in solid phase; (ii) undergo at least a partial phase transition between solid and fluid phases at a pre-determined geostatic temperature; and (iii) not obstruct flow in or to the one or more of a geologic fracture, a perforation, or a wellbore at or above the pre-determined geostatic temperature. The thermoplastic material of the provided compositions may comprise one or more elastomers, polymers, and copolymers selected from halogenated elastomers, polyesters, polyamides, polyurethanes, polyimides, polyethers, polyphenylene sulfides, polysulfones, polyphenylene oxides, polydicyclopentadienes, polyacrylonitriles, polyetherimides, polyolefins, polyethylenechlorinates, polyaryletherketones, styrenes, vulcanized plastics, polyvinyls, polyacrylics, polymethacrylics, and derivatives and combinations thereof. Below the predetermined geostatic temperature, the thermoplastic material is in solid phase in the form of water-insoluble particles having one or more predetermined particle sizes in the range of from about 10 μm to about 3000 μM. Thus, the solid phase may comprise particles of a single size or within a discrete size range, or may comprise a distribution of particles of differing sizes or discrete size ranges. Above the pre-determined geostatic temperature, the thermoplastic material is in fluid phase, vapor phase, or both.

In some embodiments, the provided compositions are functional at high temperatures. For purposes of more particularly describing the nature of the invention, embodiments pertaining to materials suitable for use in EGS applications will be further described herein. However, one of skill in the art will understand that the invention is not limited to materials suitable for EGS applications. In particular, it is contemplated that the provided materials may also be used in oil and natural gas applications.

In the construction of drilled wells (including EGS wells), some problems that may routinely be encountered include: (i) loss of drilling fluid to fractures intersected by the wellbore during drilling through the rock matrix; and (ii) loss of stimulation fluid through the fractures opened during the hydraulic stimulation (opening of existing fractures, creation of new fractures, or combinations thereof) of the rock matrix. Because such fluid loss has both direct costs and indirect costs (for example, those associated with extended time for drilling rig presence) on drilling operations, materials that overcome these problems are needed.

Loss of drilling fluid to fractures is one routine problem encountered in construction of EGS wells. Such wells are drilled into a rock matrix having pre-existing fractures or having engineered fractures, and this poses problems because whenever the wellbore intersects a fracture, the fracture can open and expand due to drilling fluid hydrostatic pressure. This creates an undesirable flow path for the drilling fluid, and such loss of drilling fluid from the wellbore can markedly reduce drilling effectiveness, increase costs, and hinder the subsequent completion of drilling operations. In conventional oilfield practice, a fracture can be plugged with a Lost Circulation Material (LCM) that can be either a particulate plugging material or a settable liquid. However, such LCMs are not suitable for EGS reservoirs where the wellbore can often reach temperatures of over 150° C. At such temperatures, materials for controlling fluid loss that are typically suitable for hydrocarbon wells are unsuitable. Additionally, fractures that cause the drilling fluid losses are also later required as the primary heat and fluid transport pathway between two or more EGS wells. Thus, materials for controlling fluid loss in EGS must be suitable for high temperature conditions and be readily and predictably removable when fracture obstruction is no longer desired. Removal of the fluid control material must be substantially complete and leave no significant residue or film that restricts the existing fracture pathway. Because fractures associated with EGS can have a narrow width (for example, from 500-1500 μm), suitable fluid control materials must be dually capable of obstructing narrow fractures and being substantially removable from said fractures.

The present application provides materials that can function at high temperatures and at least partially obstruct flow of fluid and also be readily and predictably removed such that fluid flow is not obstructed. Thus, it is contemplated that the provided materials can be used to control loss of drilling fluids to fractures intersected by the wellbore during drilling through a rock matrix.

In addition to loss of drilling fluid to fractures, another routine problem encountered in construction of EGS wells is the loss of hydraulic stimulation fluid through fractures. When EGS wells are drilled to target depth, the rock matrix must be hydraulically stimulated in order to create or enhance the permeability of the matrix. In the hydraulic stimulation process, water is injected into the rock matrix under sufficient pressure to open. existing fractures that intersect the wellbore. As the pressure is increased, fractures are generated due to existing stress in the rock formations. As the fracture faces shift, the natural irregularities in the fracture faces will not permit them to re-close completely, thereby resulting in a higher permeability pathway for injected water.

The opened fractures resulting from hydraulic stimulation create the desired permeability increase in the rock matrix. However, the hydraulic stimulation process for EGS is difficult to control due to long open wellbore intervals that intersect a large number of fractures. Such fractures are basically maintained by in situ stresses that are continually being imposed on the formation. Slight variations in these in situ stresses due to depth, variance in fracture orientation, localized mechanical property variations in the reservoir rock, and other such factors dictate that some of the fractures will begin opening with considerably less hydraulic pressure than other fractures. Typically, the fractures at the more shallow depths will open at lower pressure than those deeper in the well. Once the first fracture is opened, a significant portion of the injected fluid enters the opened fracture and travels its open length of penetration into the rock matrix. The next fracture to open in the wellbore requires an increased water flow rate and likely a slightly higher pressure to overcome pre-existing in situ stresses and fluid loss. Increasing pressure in the wellbore is difficult once the first fracture opens, because increasing pressure in the open fracture increases fracture width and thus fracture flow capacity, thereby further decreasing fluid flow in the wellbore to other open fractures. In EGS wells, this has particular significance because it is economically desirable to engineer more than one fracture zone along the depth of the wellbore.

In oilfield practice, mechanical packers are often used to isolate portions of the borehole to selectively open new fractures. However, such packers are unsuitable for EGS applications because seal failure or sticking of such packers can ruin the entire EGS wellbore. Moreover, mechanical packers substantially increase drilling costs due to the required presence of a drilling rig. Oilfield diversion agents are materials designed to block undesirable fluid injection into segments of a hydrocarbon reservoir and, thereby, divert flow into other portions of the reservoir. However, organic diversion materials used in oilfield applications will not withstand the extreme temperatures and kinetics of the removal processes encountered in EGS applications, and inorganic diversion materials used in oilfield applications are extremely difficult to control at EGS application temperatures.

The present application provides materials that can withstand the high temperatures and removal kinetics encountered in EGS applications, wherein said materials are readily controllable under such conditions. Moreover, the provided materials can be used to isolate portions of the well but be removed without damage to the fracture or its effective permeability. Thus, it is contemplated that the provided materials can be used to control loss of hydraulic stimulation fluid through fractures.

In various embodiments, the provided materials are compositions comprising a thermoplastic polymeric material adapted to (i) at least partially obstruct flow in or to one or more of a geologic fracture, a perforation, or a wellbore when in solid phase; (ii) undergo at least a partial phase transition between solid and fluid phases at a pre-determined geostatic temperature; and (iii) not obstruct flow in or to the one or more of a geologic fracture, a perforation, or a wellbore at or above the pre-determined geostatic temperature. Below the pre-determined geostatic temperature, the polymeric material is in solid phase as water-insoluble particles having one or more pre-determined particle sizes in the range of from about 10 μm to about 3000 μm. Above the pre-determined geostatic temperature, the polymeric material is in fluid phase, vapor phase, or both. Thus, above the pre-determined geostatic temperature, the polymeric material is dispersed in the water, steam, drilling fluids, hydraulic stimulation fluids, or combinations thereof, present in an EGS well.

The phase transition between solid and fluid phases occurs without hydrolytic, enzymatic, or biological degradation of the thermoplastic material. However, in some embodiments, hydrolytic, enzymatic, or biological degradation of the thermoplastic material may occur at or above the pre-determined geostatic temperature. In various embodiments, when the thermoplastic material is at or above the pre-determined geostatic temperature, it has a suitably low viscosity, high mobility, or both to aid in destruction of a plug previously formed by the composition when the thermoplastic material was in the solid phase. Said destruction may occur solely by the composition itself (self-destruction), or may additionally require imposition of pressurized drilling fluid or water. In some embodiments, the thermoplastic material does not sublime or vitrify upon return to a solid phase after a phase transition from solid phase to fluid phase to solid phase.

In various embodiments, the provided compositions are adapted to be applied to drilled wells after or concomitant with cooling. Cooling of a fracture, perforation, or wellbore of a well occurs during drilling as drilling fluids, hydraulic stimulating fluids, or both, are injected into the well. Additionally, cooling may result from injection of water into an engineered reservoir. The provided compositions are adapted to be applied to a cooled well and form at least a partial obstruction in a fracture, perforation, wellbore, or combination thereof. The plug or partial plug formed is stable and capable of fully or partially restricting flow at the geostatic temperature of a cooled well, as well as at a pre-determined range of temperatures above the temperature of the cooled well. Geostatic temperature of a cooled well rises toward its native, pre-cooled state over time. As geostatic temperature rises to or above the melting point of thermoplastic material (or components thereof) in a formed plug, the plug will begin to destruct. The provided composition may be adapted to form a plug that destructs rapidly when geostatic temperature reaches a pre-determined range, or it may be adapted to form a plug that destructs slowly over a period of time when geostatic temperature reaches a pre-determined range.

The provided thermoplastic materials may, in some embodiments, comprise one or more elastomers, polymers, and copolymers. In light of the aforementioned, one of skill in the art would understand that selection of suitable elastomers, polymers, and copolymers (collectively, “polymeric materials”) is based, at least in part, upon their ability to undergo a phase change (between solid and liquid) at a specific, reproducible, and pre-determinable temperature. Suitable polymeric materials are insoluble in water, aqueous drilling fluids, or both, at geostatic temperatures associated with drilling (cooled well temperatures). Additionally, suitable polymeric materials form stable and functional plugs for fractures, perforations, wellbores, or combinations thereof, as long as geostatic temperatures remain below their melting points. Moreover, suitable polymeric materials allow for controlled release of the plug when exposed to geostatic temperatures at or above their melting points. In some embodiments, the thermoplastic materials comprise one or more suitable polymeric materials selected from halogenated elastomers, polyesters, polyamides, polyurethanes, polyimides, polyethers, polyphenylene sulfides, polysulfones, polyphenylene oxides, polydicyclopentadienes, polyacrylonitriles, polyetherimides, polyolefins, polyethylenechlorinates, polyaryletherketones, styrenes, vulcanized plastics, polyvinyls, polyacrylics, polymethacrylics, and derivatives and combinations thereof. In some embodiments, suitable polymeric materials, when mixed with water, either do not absorb water or do not appreciably absorb water. Non-limiting examples of suitable polymeric materials are provided in Table II.

TABLE II

| | | | Melting |
|---|---|---|---|
| | | Commercial | Point |
| Polymeric Material | Formula | Source | (° C.) |
| Polytetrafluoroethylene | 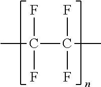 | Teflon ® (Dupont) Ultraflon ® (Lawrence Ind.) | 325 |
| Polyvinyl Fluoride | 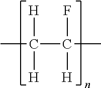 | Tedlar ® (DuPont) | 200 |
| Polyvinylidine Fluoride | 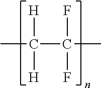 | Kynar ® (Arkema) | 175 |
| Perfluoroalkoxy | 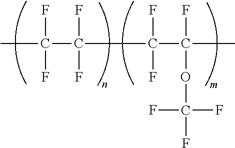 | Hyflon ® PFA (Solvay) | 305 |
| Fluorinated Ethylene Propylene | 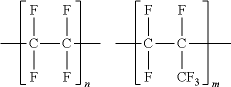 | Teflon ® FEP (DuPont) | 260 |
| Polylactic acid | 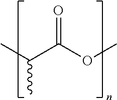 | Ingeo ® (Nature Works) | 173 |
| Polyglycolic acid | 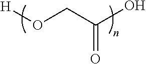 | Kuredux (Kureha) | 225 |
| Polyhydroxybutyrate | 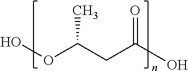 | (Goodfellow) | 175 |
| Polyethylene terephthalate | 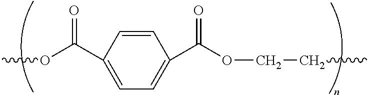 | Arnite ® (DSM Engr. Plast.) IMPET ® (Ticona) Dacron ® (Dupont) | 255 |
| Polybutylene | 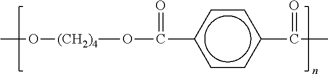 | Bergadur ® (Poly One) Crastin ® (Dupont) | 225 |
| Polymethylmeth- acrylate | 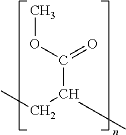 | Lucite ® (Lucite Intl.) Plexiglas ® (Altuglas Intl.) | 160 |
| Polycarbonate | 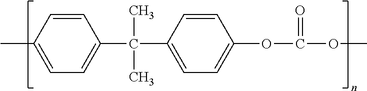 | Lexan ® (Sabic) Makrolon ® (Bayer) Calibre ® (LG-Dow) | 267 |
| Polypropylene carbonate | 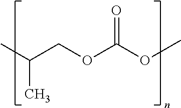 | QPAC-40 ® (Empower Materials) | 150 |
| Cellulose Acetate Butyrate | 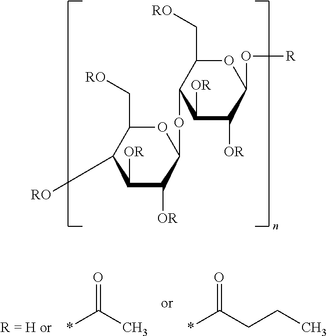 | CAB- 381-0.5 ® (Eastman) | 127-240 |
| Polyacetal | —[CH₂—O]ₙ— | Delrin ® | 175 |
| | | (DuPont) | |
| Nylon 6 | 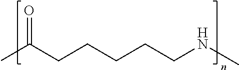 | Zytel ® (DuPont) | 220 |
| Nylon 66 | [—NH—(CH2)₆—NH—CO(CH₂)₄—CO—]ₙ | Zytel ® | 265 |
| | | (DuPont) | |
| Nylon 6-12 | [—NH—(CH2)₆—NH—CO(CH₂)₁₀—CO—]ₙ | Zytel ® | 215 |
| | | (DuPont) | |
| Polyphthalamide | 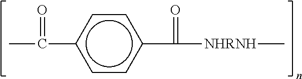 | Amodel ® (Solvay) | 349 |
| Polyparaphenylene | [—CO—C₆H₄—CO—NH—C₆H₄—NH—]ₙ | Kevlar ® | 400 |
| terephthalamide | | (DuPont) | |
| | | Nomex ® | |
| | | (DuPont) | |
| Polyurethanes | [C₁₅H₁₀N₂O₂•C₆H₁₄O₄•C₆H₁₄O₂•C₆H₁₀O₄•C₄H₁₀O₂]ₙ | Desmopan ® | 177-232 |
| | | (Bayer) | |
| | | Elastollan ® | |
| | | (Elastogran) | |
| Polystyrene | 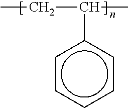 | Crystal ® (INEOS Styrenics) Daltech ® (Deltech Polymers) | 240 |
| Vulcanized plastic | n/a | ETPV ® | 205-250 |
| | | (DuPont) | |
| | | Santoprene ® | |
| | | (Exxon Mobil) | |
| Styrene-Isoprene- | n/a | Kraton ® D | 100-230 |
| Styrene | | (Kraton, Inc.) | |
| Polyphenylene sulfide | 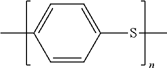 | Fortron ® (Ticona) Ryton ® (Chevron Phillips) | 282 |
| Polystyrene-co- acrylonitrile | 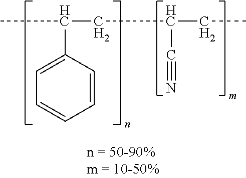 | Tyril ® (Dow) Blendex ® (Chemtura) | 200-300 |
| Polysulfone | 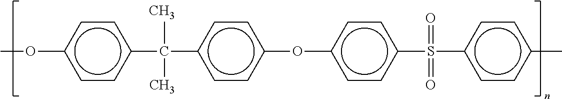 | Udel ® (Solvay) | 343 |
| Polyphenylsulfone | 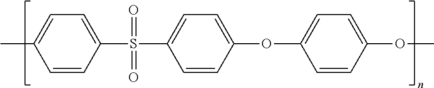 | Radel ® (Solvay) | 345-400 |
| Polyethersulfone | 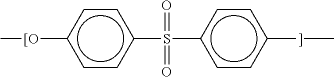 | Veradel ® (Solvay) | 370-390 |
| Polyetheretherketone | 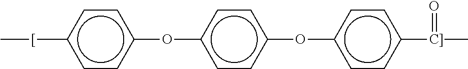 | Ketaspire ® (Solvay) | 340 |
| Polydioxanone | 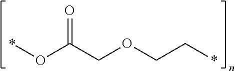 | Resomer ® (Evonik) | 225 |
| Polyaryletherketone | (—C₆H₄—O—C₆H₄—O—C₆H₄—CO—)ₙ | Avaspire ® | 365-390 |
| | | (Solvay) | |
| Polyacrylonitrile | 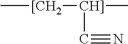 | (Scientific Polymer Products) | 317 |
| Polyimide | 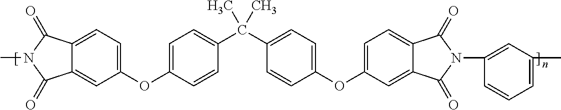 | Aurum ® (DuPont) Extem ® (GE) | 388 |
| Polyethylene | —[CH₂—CH₂]ₙ— | Marlex ® | 144-152 |
| | n >100,000 | (Chevron | 104-143 |
| | | Phillips) | |
| Polypropylene | 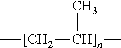 | Soft Touch ® (Dow) Polene ® (TCI Consulting) Total ® (Lone Star) Pinnacle ® (Pinnacle Polymers) | 153-232 |

Examples of suitable halogenated elastomers include, but are not limited to, polytetrafluoroethylene (PTFE), polyvinyl fluoride (PVF), polyvinyl chloride (PVC) polyvinylidene fluoride (PVDF), perfluoroalkoxy (PFA), fluorinated ethylene propylene (FEP), and derivatives and combinations thereof. As one illustrative example, if it is desirable that the thermoplastic material undergo at least a partial phase transition at a temperature in the range of from about 175° C. to about 325° C., selection of such halogenated elastomers for inclusion in the provided compositions may be appropriate.

Examples of suitable polyesters include, but are not limited to, natural polyesters such as polylactic acid (PLA), polyglycolic acid (PGA), polyhydroxybutyrate (PHB); synthetic polyesters such polyethylene terephthalate (PET), polybutylene terephthalate (PBT), polymethylmethacrylate (PMA), polycarbonate (PC), polypropylene carbonate (PPC), cellulose acetate butyrate (CAB), polyacetal (POM); and derivatives and combinations thereof. As one illustrative example, if it is desirable that the thermoplastic material undergo at least a partial phase transition at a temperature in the range of from about 173° C. to about 225° C., selection of such natural polyesters for inclusion in the thermoplastic material may be appropriate. As another illustrative example, if it is desirable that the thermoplastic material undergo at least a partial phase transition at a temperature in the range of from about 127° C. to about 267° C., selection of such synthetic polyesters for inclusion in the provided compositions may be appropriate.

Examples of suitable polyamides include, but are not limited to, nylon 6 (PA-6), nylon 66 (PA-66), nylon 6-12 (PA-6/12), polyphthalamide (PPA), polyparaphenylene terephthalamide (Aramide), and derivatives and combinations thereof. As one illustrative example, if it is desirable that the thermoplastic material undergo at least a partial phase transition at a temperature in the range of from about 215° C. to about 400° C., selection of such polyamides for inclusion in the provided compositions may be appropriate.

Examples of suitable polyethers include, but are not limited to, polyethersulfone, polyetheretherketone, polydioxanone, polyaryletherketone, and derivatives and combinations thereof. As one illustrative example, if it is desirable that the thermoplastic material undergo at least a partial phase transition at a temperature in the range of from about 225° C. to about 390° C., selection of such polyethers for inclusion in the provided compositions may be appropriate.

Examples of suitable styrenes include, but are not limited to, polystyrene, styrene-isoprene-styrene elastomer, styrene-acrylonitrile copolymer, and derivatives and combinations thereof. As one illustrative example, if it is desirable that the thermoplastic material undergo at least a partial phase transition at a temperature in the range of from about 200° C. to about 240° C., selection of such styrenes for inclusion in the provided compositions may be appropriate.

Examples of suitable polyolefins include, but are not limited to, polyethylene, polypropylene, and derivatives and combinations thereof. As one illustrative example, if it is desirable that the thermoplastic material undergo at least a partial phase transition at a temperature in the range of from about 104° C. to about 232° C., selection of such polyolefins for inclusion in the provided compositions may be appropriate.

Examples of suitable polysulfones include, but are not limited to, polysulfone, polyphenylsulfone, and derivatives and combinations thereof. As one illustrative example, if it is desirable that the thermoplastic material undergo at least a partial phase transition at a temperature in the range of from about 343° C. to about 400° C., selection of such polysulfones for inclusion in the provided compositions may be appropriate.

The thermoplastic material of the provided compositions is adapted to undergo at least a partial phase transition at pre-determined geostatic temperature. Therefore, the thermoplastic material may comprise one or more polymeric materials, wherein selection of polymeric material may be based, at least in part, on melting temperature of the polymeric material as compared to the geostatic temperature in the targeted zone of the drilled well. As one illustrative example, polycarbonate may be selected for inclusion in the provided compositions based, at least in part, upon its ability to remain in solid phase below 267° C. Melting points of other suitable polymers are shown in Table II. One of skill in the art would recognize, however, that the application is not limited to the polymeric materials listed in Table II and that melting point is only one factor in selecting a component for use in the provided composition. Additionally, one of skill in the art would recognize that because a drilled well may have more than one targeted zone, and that each zone may be a different geostatic temperature, selection of suitable polymers for inclusion in compositions may need to vary with each target zone or be such that a single composition is useful in more than one zone.

Thermoplastic materials are selected for inclusion in the provided compositions based, at least in part, on melting point being greater than the geostatic temperature of a cooled fracture, perforation, or wellbore but less than the reheated geostatic temperature of the fracture, perforation, or wellbore. In some embodiments, the thermoplastic material of the provided compositions undergoes at least a partial phase transition at a pre-determined geostatic temperature in the range of from about 120° C. to about 400° C. Accordingly, the at least partial phase transition may occur at a temperature of from about 120-130° C., 130-140° C., 140-150° C., 150-160° C., 160-170° C., 170-180° C., 180-190° C., 190-200° C., 200-210° C., 210-220° C., 220-230° C., 230-240° C., 240-250° C., 250-260° C., 260-270° C., 270-280° C., 280-290° C., 290-300° C., 300-310° C., 310-320° C., 320-330° C., 330-340° C., 340-350° C., 350-360° C., 360-370° C., 370-380° C., 380-390° C., 390-400° C., and all points therein. As one illustrative example, the at least partial phase transition may occur at a temperature in the range of from about 145° C. to about 375° C. As another illustrative example, the at least partial phase transition may occur at a temperature in the range of from about 175° C. to about 205° C. While it may be desirable in EGS applications to select thermoplastic materials that undergo a phase transition at high temperatures (including, but not limited to, temperatures in the range of from about 120° C. to about 400° C.), it is contemplated that selection of materials for hydrocarbon applications would be based, at least in part, upon a phase transition at lower temperatures. For example, it is contemplated that selection of thermoplastic materials for hydrocarbon applications may be based, at least in part, upon an ability to undergo at least a partial phase transition at temperatures in the range of from about 90° C. to about 120° C. Accordingly, the at least partial phase transition may occur at a temperature of from about 90-95° C., 95-100° C., 100-105° C., 105-110° C., 110-115° C., 115-120° C., and all points therein.

The provided compositions may, in some embodiments, comprise from about 0.01 to about 10.0% (w/w) of thermoplastic polymeric materials. Accordingly, the provided compositions may comprise from 0.01-0.05%, 0.05-0.50%, 0.50-1.0%, 1.0-1.5%, 1.5-2.0%, 2.0-2.5%, 2.5-3.0%, 3.0-3.5%, 3.0-3.5%, 3.5-4.0%, 4.0-4.5%, 4.5-5.0%, 5.0-5.5%, 5.5-6.0%, 6.0-6.5%, 6.5-7.0%, 7.0-7.5%, 7.5-8.0%, 8.0-8.5%, 8.5-9.0%, 9.0-9.5%, 9.5-10.0% (w/w), and all points therein, of polymeric materials.

In some embodiments, when in solid phase, thermoplastic material is in the form of water-insoluble particles of one or more pre-determined particle sizes in the range of from about 10 μl to about 3000 μm. Accordingly, the particles may have sizes from 10-50 μm, 50-100 μm, 100-150 μm, 150-200 μm, 200-250 μm, 250-300 μm, 300-350 μm, 350-400 μm, 400-450 μm, 450-500 μm, 500-550 μm, 550-600 μm, 600-650 μm, 650-700 μm, 700-750 μm, 750-800 μm, 800-850 μm, 850-900 μm, 900-950 μm, 950-1000 μm, 1000-1050 μm, 1050-1100 μm, 1100-1150 μm, 1150-1200 μm, 1200-1250 μm, 1250-1300 μm, 1300-1350 μm, 1350-1400 μm, 1400-1450 μm, 1450-1500 μm, 1500-1550 μm, 1550-1600 μm, 1600-1650 μm, 1650-1700 μm, 1700-1750 μm, 1750-1800 μm, 1800-1850 μm, 1850-1900 μm, 1900-1950 μm, 1950-2000 μm, 2000-2050 μm, 2050-2100 μm, 2100-2150 μM, 2150-2200 μm, 2200-2250 μm, 2250-2300 μm, 2300-2350 μm, 2350-2400 μm, 2400-2450 μm, 2450-2500 μm, 2500-2550 μm, 2550-2600 μm, 2600-2650 μm, 2650-2700 μm, 2700-2750 μm, 2750-2800 μm, 2800-2850 μm, 2850-2900 μm, 2900-2950 μm, 2950-3000 μm, and all points therein. As one illustrative example, the water-insoluble particles may have one or more pre-determined particle sizes in the range of from about 50 μm to about 1500 μm.

The provided water-insoluble particles may, in some embodiments, have particle sizes of two or more pre-determined sizes, or three or more pre-determined sizes in the range of from about 10 μm to about 3000 μm. As one illustrative example, the water-insoluble particles may be present as a size distribution with particles having a size of from about 10 μm to about 500 μm, particles having a size of from about 500 μm to about 1000 μm, and particles having a size of from about 1000 μm to about 3000 μm. As another illustrative example, the water-insoluble particles may be present as a size distribution of particles, wherein the thermoplastic material comprises 0-30% particles having a particle size of from about 50 μm to about 300 μm, 40-70% particles having a particle size of from about 300 μm to about 840 μm, and 15-45% particles having a particle size of from about 840 μm to about 1680 μm.

In some embodiments, it is contemplated that the provided compositions may comprise two or more polymeric materials; alternatively, three or more polymeric materials; alternatively, four or more polymeric materials; wherein the polymeric materials are selected based, at least in part, on their melting temperatures within one or more pre-determined ranges of geostatic temperature. In some embodiments, the provided compositions may have differing polymeric materials with differing particle sizes. As one illustrative example, a composition may comprise a first polymeric material having particles from about 10 μm to about 1000 μm, and one or more additional polymeric materials having particles from about 1000 μm to about 3000 μm.

In some embodiments, the water-insoluble particles may be selected from a variety of types, including but not limited to, fibers, flakes, and crystals. Additionally, particles may be selected from a variety shapes including, but not limited to, cubic, spherical, and amorphous. As one illustrative example, a cubic shape may be selected to control packing configuration for an inelastic particle. As another illustrative example, a spherical shape may be selected to control packing configuration for an elastic particle. Shape, size, size distribution, or combinations thereof, may be selected to control packing properties. As one illustrative example, in order to have minimal space between particles within the plug matrix, the shape of the particles may be selected to be spherical and a size distribution of increasingly smaller spheres may be selected, thereby increasing packing density and pressure drop across a formed plug.

In various embodiments, the provided compositions may further comprise one or more binders. Suitable binders are those adapted to be water-insoluble particles below a first pre-determined range of geostatic temperature and water-soluble at or above a second pre-determined range of geostatic temperatures. Below the second pre-determined range of geostatic temperatures, suitable binders are able to aggregate and bridge water-insoluble particles of the solid phase thermoplastic material. Thus, binders provide cohesive forces to assist the thermoplastic material particles in forming a plug to temporarily obstruct or partially obstruct one or more of a fracture, perforation, or wellbore. Binders may, in some embodiments, at least partially absorb water, become tacky in water, develop adhesive properties in water, form a film in water, or combinations thereof. The provided compositions are designed such that when they are applied in a drilled well, the thermoplastic material particles contained therein will begin to form a plug to at least partially obstruct one or more of a fracture, perforation, or wellbore. Additionally, the compositions are designed such that in those that further comprise binders, the binder material (whether in the form of water-insoluble particles or aqueous solution) will flow through the fracture, perforation, or wellbore as the plug is forming. As the plug develops, it is believed that it will act as a filter with the binder material being a part of the filtrate. Thus, the composition of binder material in the plug will be small as compared to the composition of thermoplastic material but will grow as the plug develops. The provided compositions are further designed such that as the composition of binder in the developing plug increases, it will effect aggregation and bridging of the thermoplastic material particles. At or above a pre-determined range of geostatic temperature, the plug will begin to destruct due to physical changes in binder material, thermoplastic material, or both. For example, a binder may become water-soluble at or above a pre-determined geostatic temperature. As another example, thermoplastic material may undergo a phase transition. The provided compositions are additionally designed such that as temperature increases, the fracture, perforation, or wellbore will become increasingly less obstructed as the plug destructs. At or above a pre-determined geostatic temperature, it is believed that the binder material, thermoplastic material, or both, will be dispersed in the water, steam, drilling fluids, hydraulic stimulating fluids, or combinations thereof, present in an EGS well.

Binders may be selected from a variety of natural and synthetic materials. Examples include, but are not limited to, proteins, starches, elastomers, thermoplastics, and emulsions. As one illustrative example, a provided composition may include one or more fully hydrolyzed polyvinylacetates, polyvinyl alcohol (PVA), binders. Suitable polyvinyl alcohols for use as binders in the provided compositions include, but are not limited to, Elvanol® 70-04 (DuPont), Elvanol® 70-06 (DuPont), Elvanol® 70-20 (DuPont), Elvanol® 70-30 (DuPont), Elvanol® 70-62 (DuPont), Elvanol® 70-63 (DuPont), Elvanol® 70-75 (DuPont), Elvanol® 71-30 (DuPont), Elvanol® 90-50 (DuPont), Elvanol® 75-15 (DuPont), Elvanol® 80-18 (DuPont), and Elvanol® 85-82 (DuPont). Selection of binder for inclusion the provided compositions may be based, at least in part, upon solubility in aqueous fluids. In some embodiments, suitable binders water-insoluble below (and water-soluble at or above) geostatic temperatures in the range of from about 60° C. to about 320° C. Accordingly, suitable binders may become water-soluble at geostatic temperatures in the range of from about 60° C. to about 320° C. Accordingly, the melting point of a binder may be from about 60-70° C., 70-80° C., 80-90° C., 90-100° C., 100-110° C., 110-120° C., 120-130° C., 130-140° C., 140-150° C., 150-160° C., 160-170° C., 170-180° C., 180-190° C., 190-200° C., 200-210° C., 210-220° C., 220-230° C., 230-240° C., 240-250° C., 250-260° C., 260-270° C., 270-280° C., 280-290° C., 290-300° C., 300-310° C., 310-320° C., and all points therein. As one illustrative example, a suitable binder for inclusion in the provided compositions may be a polyvinyl alcohol that becomes water-soluble at a geostatic temperature in the range of 70-110° C. The provided compositions are designed such that as such a binder becomes solvated in surrounding fluids, a gap or hole will be formed in the plug formation, thereby increasing permeability of the plug. As flow increases through the plug, geostatic temperature decreases due to the cooling effect of increased flow. It is believed that said cooling may delay further destruction of the remainder of the plug until geostatic temperature reaches the melting point of the thermoplastic material. Thus, selection of binder for inclusion in the provided compositions may be based upon ability to provide cohesive and adhesive properties that assist in formation of the plug, may be based upon ability to selectively destruct the plug formation, or combinations thereof.

The provided compositions may, in some embodiments, comprise from about 0 to about 10% (w/w) of binder material. Accordingly, the provided compositions may comprise from 0.00-0.05%, 0.05-0.50%, 0.50-1.0%, 1.0-1.5%, 1.5-2.0%, 2.0-2.5%, 2.5-3.0%, 3.0-3.5%, 3.0-3.5%, 3.5-4.0%, 4.0-4.5%, 4.5-5.0%, 5.0-5.5%, 5.5-6.0%, 6.0-6.5%, 6.5-7.0%, 7.0-7.5%, 7.5-8.0%, 8.0-8.5%, 8.5-9.0%, 9.0-9.5%, 9.5-10% (w/w), and all points therein, of binder materials.

In some embodiments, it is contemplated that for applications such as hydrocarbon wells, a water-insoluble fiber (such as polyester or polyamide fibers) may also be useful in plug formation to provide additional structural integrity.

According to some embodiments, the provided compositions may further comprise one or more surfactants. ,In principle, the surfactant used can be any known surfactant and can be cationic, anionic, nonionic, and/or amphoteric. Selection of surfactant may be based, at least in part, upon surface charge or polarity of the thermoplastic material, binder material, or both, also selected for inclusion in the composition. Cationic surfactants include, but are not limited to, primary, secondary, and tertiary amines or permanently charged quaternary ammonium compounds. Non-limiting examples of cationic surfactants are quaternary ammonium hydroxides such as cetyl trimethylammonium hydroxide, octyl trimethyl ammonium hydroxide, dodecyl trimethyl ammonium hydroxide, hexadecyl trimethyl ammonium hydroxide, octyl dimethyl benzyl ammonium hydroxide, decyl dimethyl benzyl ammonium hydroxide, didodecyl dimethyl ammonium hydroxide, dioctadecyl dimethyl ammonium hydroxide, tallow trimethyl ammonium hydroxide and coco trimethyl ammonium hydroxide as well as corresponding salts (such as cetyl trimethylammonium chloride) of these materials, fatty amines and fatty acid amides and their derivatives, basic pyridinium compounds, and quaternary ammonium bases of benzimidazolines and poly(ethoxylated/propoxylated) amines.

Anionic surfactants include, but are not limited to, sulfates, sulfonates, phosphates, and carboxylates. Non-limiting examples of anionic surfactants are alkyl sulfates such as lauryl sulfate, polymers such as acrylates/C₁₀₋₃₀ alkyl acrylate crosspolymer alkylbenzenesulfonic acids and salts such as hexylbenzenestilfonic acid, octylbenzenesulfonic acid, decylbenzenesulfonic acid, dodecylbenzenesulfonic acid, cetylbenzenesulfonic acid and myristylbenzenesulfonic acid; the sulfate esters of monoalkyl polyoxyethylene ethers; alkylnapthylsulfonic acid; alkali metal sulfoccinates, sulfonated glyceryl esters of fatty acids such as sulfonated monoglycerides of coconut oil acids, salts of sulfonated monovalent alcohol esters, amides of amino sulfonic acids, sulfonated products of fatty acid nitriles, sulfonated aromatic hydrocarbons, condensation products of naphthalene sulfonic acids with formaldehyde, sodium octahydroanthracene sulfonate, alkali metal alkyl sulfates, ester sulfates, and alkarylsulfonates. Anionic surfactants include alkali metal soaps of higher fatty acids, alkylaryl sulfonates such as sodium dodecyl benzene sulfonate, long chain fatty alcohol sulfates, olefin sulfates and olefin sulfonates, sulfated monoglycerides, sulfated esters, sulfonated ethoxylated alcohols, sulfosuccinates, alkane sulfonates, phosphate esters, alkyl isethionates, alkyl taurates, and alkyl sarcosinates. In some embodiments, the provided compositions comprise one or more anionic surfactants.

Nonionic surfactants include, but are not limited to, fatty alcohols, polyoxyethylene glycol alkyl ethers and glycerol alkyl esters. Non-limiting examples of non-ionic surfactants are condensates of ethylene oxide with long chain fatty alcohols or fatty acids such as a C12-C16 alcohol, condensates of ethylene oxide with an amine or an amide, condensation products of ethylene and propylene oxide, esters of glycerol (such as glyceryl laurate), sucrose, sorbitol, fatty acid alkylol amides, sucrose esters, fluoro-surfactants, fatty amine oxides, polyoxyalkylene alkyl ethers such as polyethylene glycol long chain alkyl ether, polyoxyalkylene sorbitan ethers, polyoxyalkylene alkoxylate esters, polyoxyalkylene alkylphenol ethers, ethylene glycol propylene glycol copolymers and alkylpolysaccharides, polymeric surfactants such as polyvinyl alcohol and polyvinylmethylether.

Non-limiting examples of amphoteric surfactants include cocamidopropyl betaine, cocamidopropyl hydroxysulfate, cocobetaine, sodium cocoamidoacetate, cocodimethyl betaine, N-coco-3-aminobutyric acid and imidazolinium carboxyl compounds.

The provided compositions may, in some embodiments, comprise from about 0 to about 1% (w/w) of surfactant. Accordingly, the provided compositions may comprise from 0.00-0.1%, 0.1-0.2%, 0.2-0.3%, 0.3-0.4%, 0.4-0.5%, 0.5-0.6%, 0.6-0.7%, 0.7-0.8%, 0.8-0.9%, 0.9-1% (w/w), and all points therein, of surfactant.

According to some embodiments, the provided compositions may further comprise one or more thickeners. In principle, the thickener used can be any known thickener. Suitable thickeners include, but are not limited to, polymers such as polyethylene oxide, gums such as guar gum or xanthan gum and cellulosics.

The provided compositions may, in some embodiments, comprise from about 0 to about 5% (w/w) of thickener. Accordingly, the provided compositions may comprise from 0.00-0.1%, 0.1-0.2%, 0.2-0.3%, 0.3-0.4%, 0.4-0.5%, 0.5-0.6%, 0.6-0.7%, 0.7-0.8%, 0.8-0.9%, 0.9-1.0%, 1.0-1.5%, 1.5-2.0%, 2.0-2.5%, 2.5-3%, 3-3.5%, 3.5-4.0%, 4.0-4.5%, 4.5-5% (w/w), and all points therein, of thickener.

The provided compositions may optionally also comprise additional components, such as anti-caking agents. Thus, the compositions are not intended to be limited to the components described herein.

In some embodiments, selection of components (including, but not limited to, thermoplastic materials and binding materials) for inclusion in the provided compositions may be based upon one or more of: (i) melting point of the component; (ii) chemical and structural stability of the component at the geostatic temperature (up to melting point of the component) of the fracture, perforation, or wellbore before, during, or after drilling; (iii) ability to readily and controllably process the component into free flowing particles in the range of about 10-3000 Inn, with a controlled particle size distribution (mean particle size and variance); (iv) ability to process on commercially available size reduction equipment; (v) contribution to the degree and rate of plug destruction and removal (at or above the component's initial melting point); (vi) degree of component residue (or any degradation products) remaining in the fracture, perforation, or wellbore upon destruction and removal of plug; (vii) whether or not the component (or any degradation products) is non-toxic and non-corrosive; (viii) economical and cost effective material cost, (ix) size reduction processing cost; (x) biodegradability; (xi) component particle elasticity; (xii) coefficient of expansion; (xiii) tensile, compressive and shear properties; (xiv) particle cohesive properties in an aqueous environment; and (xv) particle type, shape, or both.

In some embodiments, the provided compositions are adapted to form a plug that is able to at least partially obstruct one or more of a fracture, perforation, or wellbore when subjected to high temperature and high fluid pressures. As one illustrative example, the provided compositions may be able to form and maintain a plug when subjected to a pre-determined range of geostatic temperatures and fluid pressures of up to about 6000 psi. Accordingly, a composition may be able to maintain an at least partially obstructing plug when subjected to fluid pressures of from about 1-500 psi, 500-1000 psi, 1000-1500 psi, 1500-2000 psi, 2000-2500 psi, 2500-3000 psi, 3000-3500 psi, 3500-4000 psi, 4000-4500 psi, 4500-5000 psi, 5000-5500 psi, 5500-6000 psi, and all points therein. In some embodiments, it is contemplated that removal of a plug may be assisted with application fluid pressures above a pre-determined threshold. Typically, the threshold would be at or below the pressures used in hydraulic stimulation to stimulate fractures. As one illustrative example, a provided composition may be adapted to maintain an at least partially obstructing plug when subjected to fluid pressures below 5000 psi, and then destruct when subjected to fluid pressures above 5000 psi. As another illustrative example, a provided composition may be adapted to maintain an at least partially obstructing plug when subjected to fluid pressures between from about 4000 to about 5000 psi, and then destruct or begin to destruct when subjected to higher fluid pressures.

In various embodiments, the provided compositions are adapted to form at least partial obstructions under a first set of pre-determined conditions and then at least partially self-destruct under a second set of pre-determined conditions. Thus, it is not necessary to apply acids or other materials typically used in the hydrocarbon industry to remove Lost Circulation Material (LCM) or other plugging materials.

The provided compositions may, but are not required to be, delivered to a well site in powdered form wherein they would be mixed with water or other aqueous-based fluids to form a pumpable mixture that is then pumped into the drilled well. In some embodiments, the provided compositions are adapted to form, when mixed with water, a pumpable mixture having a density of from about 0.80 to about 1.5 g/cm³. Accordingly, a pumpable mixture formed by mixing the provided compositions with water may have a density of from about 0.80-0.90, 0.90-1.0 g/cm³, 1.0-1.1 g/cm³, 1.1-1.2 g/cm³, 1.2-1.3 g/cm³, 1.3-1.4 g/cm³, 1.4-1.5 g/cm³, and all points therein.

In light of the aforementioned, one of skill in the art would understand that the present application provides compositions adapted to temporarily and reversibly control flow in one or more of an enhanced geothermal system well, oil well, and natural gas well, the compositions comprising a thermoplastic material adapted to (i) when in solid phase, at least partially obstruct flow in one or more of a geologic fracture, a perforation, or a wellbore; (ii) undergo at least a partial phase transition between solid phase and fluid phase at a first pre-determined geostatic temperature; and (iii) not obstruct flow in or to the one or more geologic fracture, perforation, or wellbore at or above the first pre-determined geostatic temperature. In some embodiments, the compositions are adapted for use in reversibly controlling flow in an enhanced geothermal system well.

### II. Methods

In addition to materials for use in drilled wells, the present application provides methods contemplated to be useful in controlling flow in drilled wells (one or more of oil, natural gas, and EGS wells) by at least partially obstructing one or more of a geologic fracture, perforation, or wellbore in a reversible manner. As one illustrative example, the provided methods are adapted to temporarily obstruct fractures encountered in the drilling and formation of an EGS well, and are thus believed to be suitable for use under the conditions associated with EGS.

In some of the various embodiments, provided are methods for treating a drilled well to reversibly control flow in or to one or more of a geologic fracture, a perforation, or wellbore. The provided methods comprise treating the drilled well with a provided composition. Thus, the provided methods comprise preparing a pumpable mixture by mixing with water a composition comprising a thermoplastic material adapted to (a) when in solid phase, at least partially obstruct flow in or to one or more of a geologic fracture, perforation, or wellbore; (b) undergo at least a partial phase transition between solid and fluid phases at a first pre-determined geostatic temperature; and (c) not obstruct flow in or to the one or more geologic fracture, perforation, or wellbore at or above the first pre-determined geostatic temperature. In some embodiments, the thermoplastic material of the composition comprises one or more of halogenated elastomers, polyesters, polyamides, polyurethanes, polyimides, polyethers, polyphenylene sulfides, polysulfones, polyphenylene oxides, polydicyclopentadienes, polyacrylonitriles, polyetherimides, polyolefins, polyethylenechlorinates, polyaryletherketones, styrenes, vulcanized plastics, polyvinyls, polyacrylics, polymethacrylics, and derivatives and combinations thereof. Non-limiting examples of suitable thermoplastic materials are described in Table II. In some embodiments, the solid phase thermoplastic material may be in the form of water-insoluble particles having one or more pre-determined particle sizes in the range of from 10 μm to 3000 μm. In some embodiments, the thermoplastic material is selected for its ability to undergo at least a partial phase transition at a pre-determined geostatic temperature in the range of from about 120° C. to about 400° C.

The composition (and pumpable mixture) may, in some embodiments, further comprise one or more binders adapted to aggregate and bridge the water-insoluble particles of the solid phase thermoplastic material. In some embodiments, suitable binders are water-insoluble below, and water-soluble above, a second pre-determined geostatic temperature; wherein the second pre-determined geostatic temperature is less than the first pre-determined geostatic temperature. As one illustrative example, binders may be selected from polyvinyl alcohols. In some embodiments, the composition (and pumpable mixture) further comprises one or more surfactants, thickeners, or other components. Additionally, in some embodiments, the pumpable mixture may have a density of from 0.80 to 1.5 g/cm³.

It is contemplated that the provided methods may further comprise injecting the pumpable mixture into one or more target zones of the drilled well. Additionally, the provided methods may comprise causing the pumpable mixture to aggregate in the one or more of a geologic fracture, perforation, or wellbore of the one or more target zones. In various embodiments, the provided compositions are adapted to be applied to drilled wells after or concomitant with cooling. Cooling of a fracture, perforation, or wellbore of a well occurs during drilling as drilling fluids, hydraulic stimulating fluids, or both, are injected into the well. Additionally, cooling may result from injection of water into an engineered reservoir.

The provided compositions are adapted to be applied to a cooled well and form at least a partial obstruction in a fracture, perforation, wellbore, or combination thereof. Thus, in some embodiments, the provided methods may further comprise decreasing flow in or to the one or more geologic fracture, perforation, or wellbore by allowing the aggregated pumpable mixture to form at least a partial plug.

The provided compositions are adapted to form at least a partial plug when geostatic temperature is less than the melting point of the thermoplastic materials in the plug, the optional binder materials in the plug, or both, and then at least partially destruct at or above the geostatic temperature of a heated (or reheated) fracture, perforation, or wellbore. Thus, in some embodiments, the provided methods may further comprise increasing flow in or to the one or more geologic fracture, perforation, or wellbore by allowing temperature of the one or more target zones and at least partial plug therein to increase to at least the first pre-determined geostatic temperature; wherein at or above the first pre-determined geostatic temperature, the at least partial plug at least partially destructs. In some embodiments, the methods may comprise allowing the temperature of the one or more target zones and at least partial plug therein to increase to a geostatic temperature in the range of from 120° C. to 400° C.; alternatively, from 145° C. to 375° C.; alternatively, from 175° C. to 205° C.

In light of the aforementioned, one of skill in the art would understand that provided in the present application are contemplated methods of treating a drilled well (including, but not limited to, those of EGS, oil, or gas) to reversibly control flow in or to one or more of a geologic fracture, a perforation, or wellbore, the method comprising (i) preparing a pumpable mixture by mixing with water a composition comprising a thermoplastic material adapted to (a) when in solid phase, at least partially obstruct flow in or to the one or more geologic fracture, perforation, or wellbore; (b) undergo at least a partial phase transition between solid and fluid phases at a first pre-determined geostatic temperature; and (c) not obstruct flow in or to the one or more geologic fracture, perforation, or wellbore at or above the first pre-determined geostatic temperature; (ii) injecting the pumpable mixture into one or more target zones of a drilled well selected from an enhanced geothermal system well, an oil well, and a natural gas well; (iii) causing the pumpable mixture to aggregate in the one or more of a geologic fracture, perforation, or wellbore of the one or more target zones; (iv) decreasing flow in or to the one or more geologic fracture, perforation, or wellbore by allowing the aggregated pumpable mixture to form at least a partial plug; and (v) increasing flow in or to the one or more geologic fracture, perforation, or wellbore by allowing temperature of the one or more target zones and at least partial plug therein to increase to at least the first pre-determined geostatic temperature; wherein at or above the first pre-determined geostatic temperature, the at least partial plug at least partially destructs. It is believed that the provided methods may, in some embodiments, be used to treat a well of an enhanced geothermal system. In some embodiments, the provided methods are adapted to be used to treat one target zone of a drilled well. In some embodiments, the provided methods are adapted to be used to treat two or more target zones within the same well. As one illustrative example, it is contemplated that the provided methods may be used to treat an EGS well having two or more target zones, wherein a target zone at shallower depth may undergo drilling, hydraulic stimulation, or both; be treated by the provided methods to obstruct or partially obstruct one or more geologic fractures therein; then drilling, hydraulic stimulation, or both, can continue to or at a target zone at greater depth while drilling fluids, hydraulic stimulation fluids, or both, are diverted from the shallower target zone. Thereafter, when drilling and hydraulic stimulation have ceased, the geostatic temperature of the cooled well will rise and it is believed that the treated target zones will become unobstructed, thereby allowing permeability to resume.

### EXAMPLES

The described embodiments will be better understood by reference to the following examples which are offered by way of illustration and which one of skill in the art will recognize are not meant to be limiting.

### Example 1

An objective was to develop a composition for use in an EGS well that would form, in a fracture, at least a partial plug that is stable and functional (i.e. able to decrease flow) at 148° C. for a two week period, but would thereafter destruct and be substantially removed (within two weeks but ideally in a matter of hours) from the fracture without substantial residue remaining after exposure to geostatic temperature of 260° C. To achieve this objective, the following thermoplastic polymers were tested in the laboratory under simulated field conditions (materials were placed in an aluminum weighing dish, left in an oven at a specified temperature for a specified period of time, then reweighed): polycarbonate, polylactide, styrene-isoprene copolymer, polyvinylidene flouride, and polypropylene.

The test results are described in Table III and Table IV. The data clearly indicated that, to fill the performance objectives, the polycarbonate was the clear selection. It was the only polymer of the five tested that completely met the stated cited critical temperature stability requirements. The tests also showed that at a lower temperature EGS well (176-205° C.), polylactide may also meet the temperature performance requirements. Polylactide is also biodegradable, which may be advantageous.

TABLE III

| | 300° F./148.9° C. | | | | |
|---|---|---|---|---|---|
| Material | Initial Weight | 7 days | % Loss | 14 days | % Loss |
| Polylactide | 3.00 | 0.00 | 100.0% | NA | NA |
| Polycarbonate | 3.00 | 2.52 | 16.0% | 2.22 | 26.0% |
| Styrene- | 3.00 | 2.86 | 4.7% | 3.45 | −15.0% |
| isoprene | | | | | |
| copolymer | | | | | |
| Polyvinylidene | 3.00 | 2.78 | 7.3% | 2.72 | 9.3% |
| flouride | | | | | |
| Polypropylene | 3.00 | 2.67 | 11.0% | 2.25 | 25.0% |

TABLE IV
500° F./260° C.

| | Initial | | | | | | | | | | |
|---|---|---|---|---|---|---|---|---|---|---|---|
| Material | Weight | 7 days | % Loss | 14 days | % Loss | 21 Day | % Loss | 26 Day | % Loss | 33 Day | % Loss |
| Polylactide | could not be tested at these conditions | | | | | | | | | | |
| Polycarbonate | 3.22 | 0.00 | 100.0% | NA | NA | NA | NA | NA | NA | NA | NA |
| Styrene-isoprene | 3.31 | 4.26 | −28.7% | 4.51 | −36.3% | 3.6 | −8.8% | 2.8 | 15.4% | 2.81 | 15.1% |
| copolymer | | | | | | | | | | | |
| Polyvinylidene | 3.62 | 2.99 | 17.4% | 2.58 | 28.7% | 2.03 | 43.9% | 1.95 | 46.1% | 1.75 | 51.7% |
| flouride | | | | | | | | | | | |
| Polypropylene | 3.12 | 2.85 | 8.7% | 3.06 | 1.9% | 2.85 | 8.7% | 2.85 | 8.7% | 2.8 | 10.3% |

### Example 2

With an objective to develop compositions that are stable at temperatures in the range of from 120-316° C. for a two week period, but thereafter will completely destruct (within two weeks, but ideally within a matter of hours) when the composition is exposed to a temperature increase in the range of from 37-94° C., it is contemplated that one or more of the following thermoplastic polymers will meet the objective under simulated and/or actual field conditions and be suitable for use in reversibly controlling flow in drilled wells:
1. Fluorinated or Chlorinated Elastomers, including but not limited to, polytetrafluoroethylene
2. Natural Polyesters, including but not limited to, polylactic acid
3. Synthetic Polyesters, including but not limited to, polyethylene terephthalate
4. Polycarbonates
5. Polyamides, including but not limited to, polyphthalamides
6. Polyurethanes
7. Polyimides, including but not limited to poly-oxydiphenylene-pyromellitimide
8. Polyethers, including but not limited to, polysulfone
9. Polyphenylene Sulfide (or Polyphenylene Oxide)
10. Polydicyclopentadiene
11. Polyacrylonitriles
12. Polyetherimides
13. Polypropylenes
14. Polyethylenechlorinates
15. Polyaryletherketone
16. Polystyrene, and its copolymers

It is further contemplated that these thermoplastic materials will be suitable for use in controlling flow of drilling fluid, hydraulic stimulating fluid, water, or steam in or to one or more of a fracture, perforation, or wellbore in an EGS well.

### Example 3

Conditions associated with various EGS wells (each having different geological properties) were ascertained, and the performance requirements of compositions for temporarily sealing fractures in those wells were determined (Table V). Such data may be useful in determining which thermoplastic polymeric materials described in Example 2 may be selected for use in specific EGS wells. For example, “Material Class No. 4” referenced in Table V represents a class of desired performance properties of thermoplastic materials, wherein it is contemplated that materials having said properties would be suitable for use in the conditions of the associated specific EGS well.

TABLE V

| Material | Temp. Stability Performance Desired | | |
|---|---|---|---|
| Class | Stable¹ @ | Temp | |
| No. | Temp. | Increase | Melts² @ Temp. |
| 1 | 250° F./121.1° C. | 100° F./37.8° C. | 350° F./176.7° C. |
| 2 | 250° F./121.1° C. | 200° F./93.3° C. | 450° F./232.2° C. |
| 3 | 300° F./148.9° C. | 100° F./37.8° C. | 400° F./204.4° C. |
| 4 | 300° F./148.9° C. | 200° F./93.3° C. | 500° F./260° C. |
| 5 | 400° F./204.4° C. | 100° F./37.8° C. | 500° F./260° C. |
| 6 | 400° F./204.4° C. | 200° F./93.3° C. | 600° F./315.6° C. |
| 7 | 500° F./260° C. | 100° F./37.8° C. | 600° F./315.6° C. |
| 8 | 500° F./260° C. | 200° F./93.3° C. | 700° F./371.1° C. |

¹Two weeks, minimum
²Two weeks, maximum

### Example 4

One example of a provided composition is:

| Component | Material | % (w/w) |
|---|---|---|
| Thermoplastic | Polycarbonate | 85 |
| polymer | | |
| Binder polymer | Elvanol ® 71-30 (DuPont) | 15 |
| | | 100 |

### Example 5

One example of a contemplated pumpable mixture expected to be useful in reversibly controlling flow in or to one or more of a fracture, perforation, or wellbore in an EGS well is:

| Component | Material | % (w/w) |
|---|---|---|
| Thermoplastic polymer | Pinnacle ® PP1112 | 0.85 |
| | (Pinnacle Polymers) | |
| Optional Binder polymer | Elvanol ® 71-30 (DuPont) | 0.15 |
| Optional Anti-caking | Syloid ® 266 (W.R. Grace & Co.) | 0.01 |
| agent | | |
| Optional Surfactant | Sodium Laurel Sulfate | 0.01 |
| Optional Thickener | Polyox ® WSR (Dow) | 0.30 |
| Water | | 98.68 |
| | | 100.00 |

### Example 6

One generalized example of making a provided composition (prior to mixture with water) is described herein.

1. Grind three (3) individual sets of the thermoplastic polymer (for example, polycarbonate) so as to achieve the following three (3) general particle size ranges:

| Set No. | Particle Size Range (μm)¹ |
|---|---|
| 1 | 1680-840 |
| 2 | 840-300 |
| 3 | 300-50 |

¹One of skill in the art would understand that particle size ranges may change for the specific materials used, as well as for the geological conditions that are present at each drilled well.

2. Classify each set, individually, so as to remove any/all particles that do not meet the size range desired for the respective set.

3. Into a V-blender, add the three (3) individual thermoplastic polymer sets in the following proportions:

| Set No. | Wt. %¹ |
|---|---|
| 1 | 30 |
| 2 | 55 |
| 3 | 15 |

¹One of skill in the art would understand that particle distributions may change for the specific materials used, as well as for the geological conditions that are present at each drilled well.

4. Blend for a suitable period of time to achieve uniform particle distribution (for example, 1 hour).

5. Optionally, add anti-caking agent (for example, 1.17% of Syloid® 266 or Syloid® 244) to the fully particle distribution of thermoplastic polymer and blend for an additional period of time to achieve uniform distribution (for example, 30 minutes).

6. Optionally, add binder particles (for example, Elvanol® 71-30) to the blender in a ratio¹ of:

| | |
|---|---|
| Thermoplastic polymeric material: | 85% |
| Binder material: | 15% |

¹One of skill in the art would understand that the ratio may change for the specific materials used, as well as for the geological conditions that are present at each drilled well.

7. Blend for a suitable period of time to achieve uniform distribution (for example, 30 minutes).

8. Incrementally, empty the final blender contents into 50 pound (50 lb) bags for shipment to the drilled well location.

### Example 7

One general example of making a pumpable mixture comprising a provided composition is described herein.

1. Add a suitable amount of water (for example, 985 gallons) to an agitated tank. Maintain maximum agitation in the tank throughout the entire process and until the tank has been completely emptied (from pumping mixture into drilled well).

2. Optionally, add surfactant (for example, 8.3 lbs./1 gallon of a 10% aqueous solution of sodium lauryl sulfate) to the tank and agitate for a suitable period of time to achieve uniform distribution.

3. Optionally, add thickener (for example, 25 lbs. of Polyox® WSR powder) to the tank and continue agitation for a suitable period of time to achieve uniform distribution.

4. Add a suitable amount of the provided composition (for example, 83 lbs. of the compositions of Examples 4-6) and agitate for a suitable period of time (for example, 30 minutes) to achieve uniform distribution.

5. Continue agitation until the tank has been pumped empty.

### Example 8

It is contemplated that one example of a composition adapted for use in hydrocarbon (oil, gas) drilled wells may comprise one or more types of water-insoluble polyethylene thermoplastic material having a melting point in the range of 90° C. to 120° C. Optionally, said composition may also comprise a polyethylene vinyl alcohol (PVA) binder (for example, Elvanol® 71-30 or other fully hydrolyzed PVA) alone or along with an additional classical binder (for example, Elvanol® 51-05). Such a composition would thus be adapted to form an at least partial plug at geostatic temperatures below 90° C. and not be removed until water at (90-100° C.) or steam (at temperatures up 125° C.) were introduced into the well, thereby causing the Elvanol 71-30 to dissolve and the water-insoluble polyethylene thermoplastic material to melt.

It is also contemplated that a composition adapted for use in hydrocarbon drilled wells may optionally comprise a water-insoluble fiber, such as polyester or polyamide fibers, to also be introduced concomitantly with the polyethylene thermoplastic particles so as to give the plug additional structural integrity.

This application should not be considered limited to the specific examples described herein, but rather should be understood to cover all aspects of the invention. Various modifications, equivalent processes, as well as numerous structures and devices to which the present invention may be applicable will be readily apparent to those of skill in the art. Those skilled in the art will understand that various changes may be made without departing from the scope of the invention, which is not to be considered limited to what is described in the specification.

What is claimed is:

1. A composition for reversibly controlling flow in one or more of an enhanced geothermal system well, oil well, and natural gas well, comprising:
a thermoplastic material adapted to (i) when in solid phase, at least partially obstruct flow in one or more of a geologic fracture, a perforation, or a wellbore; (ii) undergo at least a partial phase transition between solid phase and fluid phase at a first pre-determined geostatic temperature; and (iii) not obstruct flow in or to the one or more geologic fracture, perforation, or wellbore at or above the first pre-determined geostatic temperature;
wherein when in solid phase, the thermoplastic material is in the form of water-insoluble particles having one or more pre-determined particle sizes in the range of from 10 μm to 3000 μm.

2. A composition according to claim 1, wherein the thermoplastic material comprises one or more of halogenated elastomers, polyesters, polyamides, polyurethanes, polyimides, polyethers, polyphenylene sulfides, polysulfones, polyphenylene oxides, polydicyclopentadienes, polyacrylonitriles, polyetherimides, polyolefins, polyethylenechlorinates, polyaryletherketones, styrenes, vulcanized plastics, polyvinyls, polyacrylics, polymethacrylics, and derivatives and combinations thereof.

3. A composition according to claim 1, wherein the first pre-determined geostatic temperature is in the range of from 120° C. to 400° C.

4. A composition according to claim 1, wherein the first pre-determined geostatic temperature is in the range of from 145° C. to 375° C.

5. A composition according to claim 1, wherein the first pre-determined geostatic temperature is in the range of from 175° C. to 205° C.

6. A composition according to claim 1, wherein the water-insoluble particles have two or more pre-determined particle sizes in the range of from 10 μm to 3000 μm.

7. A composition according to claim 1, wherein the water-insoluble particles have one or more pre-determined particle sizes in the range of from 50 μm to 1500 μm.

8. A composition according to claim 1, wherein the water-insoluble particles are a size distribution with first particle sizes of from 10 μm to 500 μm, second particle sizes of from 500 μm to 1000 μm, and third particle sizes of from 1000 μm to 3000 μm.

9. A composition according to claim 1, further comprising one or more binders adapted to aggregate and bridge the water-insoluble particles of the solid phase thermoplastic material.

10. A composition according to claim 9, wherein the one or more binders are selected from proteins, starches, elastomers, thermoplastics, and emulsions.

11. A composition according to claim 10, wherein the one or more binders are water-insoluble below, and water-soluble above, a second pre-determined geostatic temperature; wherein the second pre-determined geostatic temperature is less than the first pre-determined geostatic temperature.

12. A composition according to claim 11, wherein the one or more binders are selected from polyvinyl alcohols.

13. A composition for reversibly controlling fluid flow in drilled wells of enhanced geothermal systems, comprising:
a thermoplastic material adapted to (i) when in solid phase, at least partially obstruct fluid flow in one or more of a geologic fracture, a perforation, or a wellbore in an enhanced geothermal system; (ii) undergo at least a partial phase transition from solid to fluid phase at a first pre-determined geostatic temperature in the range of from 145° C. to 375° C.; and (iii) not obstruct flow in or to the one or more geologic fracture, perforation, or wellbore at or above the first pre-determined geostatic temperature;
wherein the thermoplastic material comprises one or more of elastomers, polymers, and copolymers; and
wherein when in solid phase, the thermoplastic material is in the form of water-insoluble particles of one or more pre-determined particle sizes in the range of from 10 μm to 3000 μm.

14. A composition according to claim 13, wherein the one or more elastomers, polymers, and copolymers are selected from halogenated elastomers, polyesters, polyamides, polyurethanes, polyimides, polyethers, polyphenylene sulfides, polysulfones, polyphenylene oxides, polydicyclopentadienes, polyacrylonitriles, polyetherimides, polyolefins, polyethylenechlorinates, polyaryletherketones, styrenes, vulcanized plastics, polyvinyls, polyacrylics, polymethacrylics, and derivatives and combinations thereof.

15. A composition according to claim 13, wherein the first pre-determined geostatic temperature is in the range of from 175° C. to 205° C.

16. A composition according to claim 13, wherein the one or more pre-determined particle sizes are in the range of from 50 μm to 1500 μm.

17. A composition according to claim 13, comprising from 0 to 30% of particles having particle sizes in the range of from 10 μm to 500 μm; from 40 to 70% of particles having particle sizes in the range of from 500 μm to 1000 μm; and from 15 to 45% of particles having particle sizes in the range of from 1000 μm to 3000 μm.

18. A composition according to claim 13, further comprising one or more binders adapted to aggregate and bridge the water-insoluble particles of the solid phase thermoplastic material; wherein the one or more binders are selected from proteins, starches, elastomers, thermoplastics, and emulsions.

19. A composition according to claim 18, wherein the one or more binders are selected from polyvinyl alcohols.

20. A composition according to claim 13, comprising from 0.05 to 10.00% (w/w) of the thermoplastic polymeric material.

21. A composition according to claim 13, wherein when mixed with water, forms a pumpable mixture having a density of from 0.80 to 1.5 g/cm³.

22. A method of treating a drilled well to reversibly control flow in or to one or more of a geologic fracture, a perforation, or wellbore, the method comprising:
(i) preparing a pumpable mixture by mixing with water a composition comprising a thermoplastic material adapted to (a) when in solid phase, at least partially obstruct flow in or to the one or more geologic fracture, perforation, or wellbore; (b) undergo at least a partial phase transition between solid and fluid phases at a first pre-determined geostatic temperature; and (c) not obstruct flow in or to the one or more geologic fracture, perforation, or wellbore at or above the first pre-determined geostatic temperature;
wherein when in solid phase, the thermoplastic material is in the form of water-insoluble particles having one or more pre-determined particle sizes in the range of from 10 μm to 3000 μm;
(ii) injecting the pumpable mixture into one or more target zones of a drilled well selected from an enhanced geothermal system well, an oil well, and a natural gas well;
(iii) causing the pumpable mixture to aggregate in the one or more of a geologic fracture, perforation, or wellbore of the one or more target zones;
(iv) decreasing flow in or to the one or more geologic fracture, perforation, or wellbore by allowing the aggregated pumpable mixture to form at least a partial plug;
(v) increasing flow in or to the one or more geologic fracture, perforation, or wellbore by allowing temperature of the one or more target zones and at least partial plug therein to increase to at least the first pre-determined geostatic temperature;
wherein at or above the first pre-determined geostatic temperature, the at least partial plug at least partially destructs.

23. A method according to claim 22, wherein the thermoplastic material of the composition comprises one or more of halogenated elastomers, polyesters, polyamides, polyurethanes, polyimides, polyethers, polyphenylene sulfides, polysulfones, polyphenylene oxides, polydicyclopentadienes, polyacrylonitriles, polyetherimides, polyolefins, polyethylenechlorinates, polyaryletherketones, styrenes, vulcanized plastics, polyvinyls, polyacrylics, polymethacrylics, and derivatives and combinations thereof.

24. A method according to claim 22, wherein the first pre-determined geostatic temperature is in the range of from 120° C. to 400° C.

25. A method according to claim 22, wherein the first pre-determined geostatic temperature is in the range of from 145° C. to 375° C.

26. A method according to claim 22, wherein the first pre-determined geostatic temperature is in the range of from 175° C. to 205° C.

27. A method according to claim 22, wherein the composition further comprises one or more binders adapted to aggregate and bridge the water-insoluble particles of the solid phase thermoplastic material.

28. A method according to claim 27, wherein the one or more binders are selected from proteins, starches, elastomers, thermoplastics, and emulsions.

29. A method according to claim 27, wherein the one or more binders are water-insoluble solids below, and water-soluble above, a second pre-determined geostatic temperature; and wherein the second pre-determined geostatic temperature is less than the first pre-determined geostatic temperature.

30. A method according to claim 22, wherein the pumpable mixture further comprises one or more surfactants.

31. A method according to claim 22, wherein the drilled well is of an enhanced geothermal system.

32. A method according to claim 22, wherein the pumpable mixture has a density of from 0.80 to 1.5 g/cm³.
